(19) United States
(12) Patent Application Publication
(10) Pub. No.: US 2024/0172802 A1
(43) Pub. Date: May 30, 2024

(54) AEROSOL-GENERATING DEVICE INCLUDING A SEALING MEMBER

(71) Applicant: KT&G CORPORATION, Daejeon (KR)

(72) Inventors: Dong Sung KIM, Seoul (KR); Heon Jun JEONG, Seoul (KR); Won Kyeong LEE, Gyeonggi-do (KR); Jae Sung CHOI, Gyeonggi-do (KR)

(73) Assignee: KT&G CORPORATION, Daejeon (KR)

(21) Appl. No.: 17/793,239

(22) PCT Filed: Feb. 4, 2022
(86) PCT No.: PCT/KR2022/001743

§ 371 Date: Jul. 15, 2022

(30) Foreign Application Priority Data
Feb. 19, 2021 (KR) 10-2021-0022596

(51) Int. Cl. A24F 40/48; A24F 40/05; A24F 40/10; A24F 40/20; A24F 40/30; A24F 40/42; A24F 40/44; A24F 40/46; B06B 1/06; C09K 3/10; H05B 3/42

(52) U.S. Cl. CPC A24F 40/48; A24F 40/05; A24F 40/10; A24F 40/20; A24F 40/30; A24F 40/42; A24F 40/44; A24F 40/46; B06B 1/0644; C09K 3/10; H05B 3/42; B06B 2201/77; C09K 2200/0607; C09K 2200/0617; C09K 2200/0632; C09K 2200/065; C09K 2200/0655

(57) ABSTRACT

An aerosol-generating device includes a battery, a controller, an atomizer, and a scaling member disposed on one end of the atomizer and including a thermoplastic elastomer (TPE), wherein the thermoplastic elastomer has a melt flow index of 1.8 g/10 min to 80.0 g/10 min.

### TECHNICAL FIELD

The present disclosure relates to an aerosol-generating device including a sealing member.

### BACKGROUND ART

Recently, the demand for alternative methods to overcome the disadvantages of traditional cigarettes has increased. For example, there is growing demand for an aerosol generating device which generates aerosol by heating an aerosol generating material, rather than by combusting cigarettes. Accordingly, researches on a heating-type aerosol generating device have been actively conducted.

The aerosol-generating device may contain an aerosol-generating material in a liquid state, an aerosol in a gaseous state, a by-product, etc. When the liquid or gaseous material is introduced into the interior of the aerosol-generating device, such as a circuit board, failure or malfunction of the aerosol-generating device may be induced.

### DISCLOSURE OF INVENTION

### Technical Problem

An objective of the present disclosure is to provide an aerosol-generating device including a sealing member.

Specifically, an objective of the present disclosure is to provide a sealing member for an aerosol-generating device, having heat resistance that allows use even in a hightemperature environment and/or having durability to withstand a continuously applied external force.

Technical objectives to be achieved by the present disclosure are not limited to the objectives as described above, and other technical objectives may be inferred from the following embodiments.

### Solution to Problem

The present disclosure may provide an aerosol-generating device including a battery, a controller, an atomizer, and a sealing member disposed on one end of the atomizer and including a thermoplastic elastomer (TPE), wherein the thermoplastic elastomer has a melt flow index of 1.8 g/10 min to 80.0 g/10 min.

The present disclosure may provide a sealing member for an aerosol-generating device, the sealing member including a thermoplastic elastomer having a melt flow index of 1.8 g/10 min to 80.0 g/10 min.

Means for achieving the objectives are not limited to the above, and may include all matters that may be inferred by a person skilled in the art throughout the present specification.

### Advantageous Effects of Invention

The aerosol-generating device according to the present disclosure may have improved heat resistance and/or durability by a sealing member.

In addition, because the sealing member for an aerosol-generating device according to the present disclosure includes a thermoplastic elastomer, the heat resistance and/or durability of the aerosol-generating device may be improved, and the sealing member may be more precisely manufactured by injection molding.

The effects of the present disclosure are not limited to the above, and may include all effects inferred from a configuration to be described later.

### BRIEF DESCRIPTION OF DRAWINGS

FIG. 1 is a block diagram illustrating hardware components of the aerosol generating device according to an embodiment.

FIG. 2 is a view illustrating an example of an aerosol-generating device including a sealing member;

FIG. 3A is a view illustrating the front of a cartridge including a sealing member, and FIG. 3B is a view illustrating a side of the cartridge including the sealing member;

FIG. 4 is a view illustrating an example of an aerosol-generating device including a sealing member;

FIG. 5 is a view illustrating an example of an aerosol-generating device including a scaling member; and

FIGS. 6A to 6E are views illustrating examples of scaling members for an aerosol-generating device.

### BEST MODE FOR CARRYING OUT THE INVENTION

The present disclosure may provide an aerosol-generating device including a battery, an atomizer configured to generate an aerosol by atomizing an aerosol-generating material, and a sealing member disposed on one end of the atomizer and including a thermoplastic elastomer (TPE), wherein the thermoplastic elastomer has a melt flow index of 1.8 g/10 min to 80.0 g/10 min.

In an embodiment, the thermoplastic elastomer may include at least one of a thermoplastic styrenic copolymer (TPS), a thermoplastic vulcanized rubber (TPV), a thermoplastic polyester (TPEE), a thermoplastic polyurethane (TPU), and a thermoplastic polyolefin (TPO).

In an embodiment, the thermoplastic elastomer may have a hardness of 20 shore A to 85 shore A.

In an embodiment, the atomizer may include a first heating element and a cigarette, wherein the first heating element may be a heater having an elongated shape, which is inserted into the cigarette, the aerosol-generating device may include a support part for supporting the first heating element, and the sealing member may be in contact with both the first heating element and the support part.

In an embodiment, the sealing member may have an O-ring shape with a hollow formed in a center thereof, and the sealing member may surround the first heating element.

In an embodiment, the atomizer may include a cartridge, wherein the cartridge may include a liquid storage containing a liquid composition; a second heating element; and a liquid delivery element.

In an embodiment, the sealing member may be disposed above the liquid delivery element such that the sealing member presses the liquid delivery element.

In an embodiment, the sealing member may obstruct a flow of a generated aerosol in a predetermined direction.

In an embodiment, the aerosol-generating device may further include a movement passage through which the generated aerosol moves toward outside of the aerosol-generating device, wherein the cartridge may include an outlet for discharging the aerosol toward the movement passage, wherein the sealing member may be disposed between the movement passage and the outlet.

In an embodiment, the aerosol-generating device may further include a movement passage through which the generated aerosol moves toward outside of the aerosol-generating device, wherein at least one hole is formed in an inner wall of the movement passage, wherein the sealing member may surround the at least one hole.

In an embodiment, the aerosol-generating device may further include a movement passage through which the generated aerosol moves toward outside of the aerosol-generating device, wherein the sealing member may have a hollow formed in a center thereof, and may be in contact with an inner wall of the movement passage.

In an embodiment, the atomizer may include a liquid storage containing a liquid composition; a vibrator; a vibration-receiving unit; and a liquid delivery element.

In an embodiment, the sealing member may be disposed on one end of the liquid delivery element.

In an embodiment, the sealing member may have a disk shape and surround the liquid delivery element and at least a portion of the vibrator.

In addition, the present disclosure may provide a sealing member for an aerosol-generating device, the sealing member including a thermoplastic elastomer, wherein the thermoplastic elastomer has a melt flow index of 1.8 g/10 min to 80.0 g/10 min.

### MODE FOR THE INVENTION

With respect to the terms used to describe in the various embodiments, the general terms which are currently and widely used are selected in consideration of functions of structural elements in the various embodiments of the present disclosure. However, meanings of the terms can be changed according to intention, a judicial precedence, the appearance of a new technology, and the like. In addition, in certain cases, a term which is not commonly used can be selected. In such a case, the meaning of the term will be described in detail at the corresponding portion in the description of the present disclosure. Therefore, the terms used in the various embodiments of the present disclosure should be defined based on the meanings of the terms and the descriptions provided herein.

In addition, unless explicitly described to the contrary, the word “comprise” and variations such as “comprises” or “comprising” will be understood to imply the inclusion of stated elements but not the exclusion of any other elements. In addition, the terms “-er”, “-or”, and “module” described in the specification mean units for processing at least one function and operation and can be implemented by hardware components or software components and combinations thereof.

As used herein, expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c.

It will be understood that when an element or layer is referred to as being “over,” “above,” “on,” “connected to” or “coupled to” another element or layer, it can be directly over, above, on, connected or coupled to the other element or layer or intervening elements or layers may be present. In contrast, when an element is referred to as being “directly over,” “directly above,” “directly on,” “directly connected to” or “directly coupled to” another element or layer, there are no intervening elements or layers present. Like numerals refer to like elements throughout.

Hereinafter, the present disclosure will now be described more fully with reference to the accompanying drawings, in which exemplary embodiments of the present disclosure are shown such that one of ordinary skill in the art may easily work the present disclosure. The disclosure may, however, be embodied in many different forms and should not be construed as being limited to the embodiments set forth herein.

Hereinafter, embodiments of the present disclosure will be described in detail with reference to the drawings.

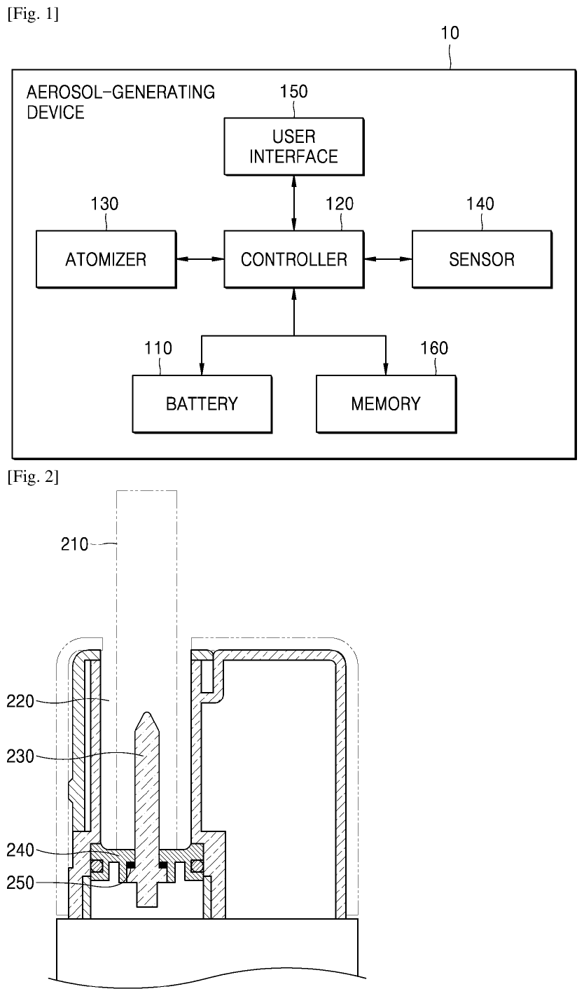

FIG. 1 is a block diagram illustrating components of the aerosol generating device according to an embodiment.

Referring to FIG. 1, the aerosol generating device 10 may include a battery 110, a controller 120, an atomizer 130, a sensor 140, a user interface 150, and a memory 160. However, the internal structure of the aerosol generating device 10 is not limited to the structures illustrated in FIG. 1. According to the design of the aerosol generating device 10, it will be understood by one of ordinary skill in the art that some of the components shown in FIG. 1 may be omitted or new components may be added.

The battery 110 supplies power to be used for the aerosol generating device 10 to operate. The battery 110 may supply power such that the atomizer 130 may be heated. In addition, the battery 110 may supply power required for operation of other components included in the aerosol generating device 10, that is, the sensor 140, the user interface 150, the memory 160, and the controller 120. The battery 110 may be a rechargeable battery or a disposable battery. For example, the battery 110 may be a lithium polymer (LiPoly) battery, but is not limited thereto.

The atomizer 130 may receive power from the battery 110 and heat an aerosol generating material. The atomizer 130 may include a heater for supplying thermal energy, and the heater may be formed of any suitable electrically resistive material. For example, the suitable electrically resistive material may be a metal or a metal alloy including titanium, zirconium, tantalum, platinum, nickel, cobalt, chromium, hafnium, niobium, molybdenum, tungsten, tin, gallium, manganese, iron, copper, stainless steel, or nichrome, but is not limited thereto. In addition, the atomizer 130 may be implemented by a metal wire, a metal plate on which an electrically conductive track is arranged, or a ceramic heating element, but is not limited thereto.

In addition, the atomizer 130 may include an induction heater. The atomizer 130 may include an electrically conductive coil for heating the aerosol generating material in an induction heating method.

In addition, the atomizer 130 may include a vibrator for supplying vibration energy, and may generate an aerosol from the aerosol-generating material by using an ultrasonic vibration method. The ultrasonic vibration method may refer to a method of generating an aerosol by atomizing an aerosol-generating material with ultrasonic vibration generated by a vibrator.

The aerosol generating device 10 may include a sensor 140. A result sensed by the sensor 140 is transmitted to the controller 120, and the controller 120 may control the aerosol generating device 10 to perform various functions such as controlling the operation of the atomizer 130, restricting smoking, determining whether an aerosol generating article (or a cartridge) is inserted, and displaying a notification.

The sensor 140 may include a puff sensor. The puff sensor may detect a user's puff based on any one of a temperature change, a flow change, a voltage change, and a pressure change. When the puff sensor is a pressure sensor that detects a change in the pressure of the air sucked through a cigarette, the pressure sensor may detect the user's puff by sensing a suction pressure, which is the pressure of the air generated by the user's puff.

In addition, the sensor 140 may include a temperature sensor. The temperature sensor may detect the temperature at which the atomizer 130 (or an aerosol generating material) is heated. The aerosol generating device 10 may include a separate temperature sensor for sensing a temperature of the atomizer 130, or the atomizer 130 itself may serve as a temperature sensor instead of including a separate temperature sensor. Alternatively, a separate temperature sensor may be further included in the aerosol generating device 10 while the atomizer 130 serves as a temperature sensor.

The user interface 150 may provide the user with information about the state of the aerosol generating device 10. The user interface 150 may include various interfacing devices, such as a display or a light emitter for outputting visual information, a motor for outputting haptic information, a speaker for outputting sound information, input/output (I/O) interfacing devices (e.g., a button or a touch screen) for receiving information input from the user or outputting information to the user, terminals for performing data communication or receiving charging power, and communication interfacing modules for performing wireless communication (e.g., Wi-Fi, Wi-Fi direct, Bluetooth, near-field communication (NFC), etc.) with external devices.

However, the aerosol generating device 10 may be implemented by selecting only some of the above-described examples of various user interface 150.

The memory 160, as a hardware component configured to store various pieces of data processed in the aerosol generating device 10, may store data processed or to be processed by the controller 120. The memory 160 may include various types of memories; random access memory (RAM), such as dynamic random access memory (DRAM) and static random access memory (SRAM), etc.; read-only memory (ROM); electrically erasable programmable read-only memory (EEPROM), etc.

The memory 160 may store an operation time of the aerosol generating device 10, the maximum number of puffs, the current number of puffs, at least one temperature profile, data on a user's smoking pattern, etc.

The controller 120 may generally control operations of the aerosol generating device 10. The controller 120 may include at least one processor. A processor can be implemented as an array of a plurality of logic gates or can be implemented as a combination of a general-purpose microprocessor and a memory in which a program executable in the microprocessor is stored. It will be understood by one of ordinary skill in the art that the processor can be implemented in other forms of hardware.

The controller 120 may analyze a result of the sensing by the sensor 140, and control the processes that are to be performed subsequently.

The controller 120 may control power supplied to the atomizer 130 so that the operation of the atomizer 130 is started or terminated, based on the result of the sensing by the sensor 140. In addition, based on the result of the sensing by the sensor 140, the controller 120 may control the amount of power supplied to the atomizer 130 and the time at which the power is supplied, so that the atomizer 130 is heated to a predetermined temperature or maintained at an appropriate temperature.

The controller 120 may control the user interface 150 based on the result of the sensing by the sensor 140. For example, when the number of puffs reaches the preset number after counting the number of puffs by using the puff sensor, the controller 120 may notify the user by using at least one of a light emitter, a motor, or a speaker that the aerosol generating device 10 will soon be terminated.

Although not illustrated in FIG. 1, the aerosol generating device 10 may form an aerosol generating system together with an additional cradle. For example, the cradle may be used to charge the battery 110 of the aerosol generating device 10. For example, while the aerosol generating device 10 is accommodated in an accommodation space of the cradle, the aerosol generating device 10 may receive power from a battery of the cradle such that the battery 110 of the aerosol generating device 10 may be charged.

One embodiment may also be implemented in the form of a computer-readable recording medium including instructions executable by a computer, such as a program module executable by the computer. The computer-readable recording medium may be any available medium that can be accessed by a computer and includes both volatile and nonvolatile media, and removable and non-removable media. In addition, the computer-readable recording medium may include both a computer storage medium and a communication medium. The computer-readable recording medium may be any available medium that can be accessed by a computer, including both volatile and nonvolatile media, and both removable and non-removable media. The communication medium typically includes computer-readable instructions, data structures, other data in modulated data signals such as program modules, or other transmission mechanisms, and includes any information transfer media.

In order to protect a circuit board and the like inside the aerosol-generating device 10 from an aerosol-generating material in a liquid state, an aerosol in a gaseous state, and a by-product, the sealing member may prevent leakage thereof or prevent the aerosol and the like from flowing in a specific direction. The sealing member may include a thermoplastic elastomer (TPE), and the thermoplastic elastomer may have a melt flow index of 1.8 g/10 min to 80.0 g/10 min, a hardness of 5 shore A to 95 shore A, a tensile strength of 0.1 kg/mm² to 1.1 kg/mm², and an elongation at break of 95% to 840%.

The thermoplastic elastomer is a polymer having properties of rubber and thermoplastic plastic at the same time. The thermoplastic elastomer may be molded in the same way as the thermoplastic plastic, and may have rubber-like elasticity and flexibility. In addition, because the thermoplastic elastomer may be molded again without loss of physical properties after molding, there is an advantage that it may be recycled, unlike conventional rubber.

According to some embodiments, the thermoplastic elastomer may be at least one of a thermoplastic styrenic copolymer (TPS), a thermoplastic vulcanized rubber (TPV), a thermoplastic polyester (TPEE), a thermoplastic polyurethane (TPU), and a thermoplastic polyolefin (TPO).

Preferably, the thermoplastic elastomer may be a thermoplastic styrenic copolymer (TPS). The thermoplastic styrenic copolymer (TPS) may be, for example, styrenebutadiene-styrene-based copolymer (SBS), styrene-isoprene-styrene-based copolymer (SIS), styrene-isobutylene-styrene-based copolymer (SIBS), styreneethylene-butadiene-styrene-based copolymer (SEBS), styreneethylene-propylene-styrene-based copolymer (SEPS), or styrene-butadiene rubber (SBR). However, the present disclosure is not necessarily limited thereto.

The thermoplastic styrene copolymer has excellent fluidity and processability, and is particularly suitable for injection molding. In addition, the hardness of the thermoplastic styrene copolymer may be adjusted in a wide range, and because the thermoplastic styrene copolymer has excellent heat resistance and weather resistance, the thermoplastic styrene copolymer may be suitable for use in an aerosol-generating device in which a cigarette or aerosol-generating material is heated. However, in order to facilitate the processing of the sealing member and improve the effect of preventing leakage of the sealing member, a thermoplastic elastomer included in the scaling member must have a melt flow index, hardness, tensile strength, and elongation at break within a certain range.

The melt flow index represents the weight of a material flowing through a capillary for 10 minutes at a constant load and temperature, and is most affected by the molecular weight and molecular weight distribution of the material. A material with a high melt flow index may be suitable for injection molding because the material has high fluidity, and a material with a low melt flow index may be suitable for extrusion molding. When the melt flow index is equal to or greater than a certain level, the melt strength of an extrudate may be low and it may be difficult for the extrudate to maintain its shape. Therefore, depending on a processing method of the sealing member, a material constituting the sealing member must have an appropriate level of melt flow index. The melt flow index of the thermoplastic elastomer is measured at a temperature of 190° C. and a load of 2.16 kg, according to the industrial standard JIS K 7210.

According to some embodiments, the thermoplastic elastomer may have a melt flow index of 1.8 g/10 min to 80.0 g/10 min, and preferably, a melt flow index of 12.5 g/10 min to 66.0 g/10 min.

The hardness refers to the degree of hardness or softness of a material. Examples of general hardness measurement methods include Vickers hardness measurement method, Brinell hardness measurement method, Rockwell hardness measurement method, and Shore hardness measurement method. The Shore hardness measurement method is widely used because it may quickly measure hardness with simple equipment. The lower the hardness of a material, the softer the material, and the higher the hardness of the material, the harder the material. When the sealing member is manufactured using a material with low hardness, packing between the sealing member and adjacent parts may be performed well as pressure is applied. However, because it is difficult to process the sealing member, the material constituting the sealing member must have an appropriate level of hardness. Hardness is measured according to the industrial standard JIS K 6301.

According to some embodiments, the thermoplastic elastomer may have a hardness of 5 shore A to 95 shore A, and preferably, a hardness of 20 shore A to 85 shore A.

The tensile strength refers to a value obtained by dividing a maximum tensile load that a specimen endures without break by the cross-sectional area of the specimen, and elongation at break refers to a rate at which the specimen is stretched until break. When the sealing member is manufactured using a material having high tensile strength and elongation at break, packing between the sealing member and adjacent parts may be performed well as pressure is applied, but durability may be reduced. In this regard, the material constituting the sealing member must have an appropriate level of tensile strength and elongation at break. Tensile strength and elongation at break are measured according to the industrial standard JIS K 6310.

According to some embodiments, the thermoplastic elastomer may have a tensile strength of 0.1 kg/mm² to 1.1 kg/mm², and preferably, a tensile strength of 0.2 kg/mm² to 1.1 kg/mm².

According to some embodiments, the thermoplastic elastomer may have an elongation at break of 95% to 840%, and preferably, an elongation at break of 355% to 840%.

As such, the thermoplastic elastomer included in the sealing member requires a melt flow index, hardness, tensile strength, and elongation at break in a certain range in order for the sealing member to prevent leakage of an aerosol-generating material or the like or to prevent an aerosol from flowing in a specific direction. The scaling member may be disposed on one end of the atomizer 130, and exemplary positions and exemplary shapes of the sealing member are described in more detail below with reference to FIGS. 2 to 6.

FIG. 2 is a view illustrating an example of an aerosol-generating device including a scaling member. Because the aerosol-generating device corresponds to the aerosol-generating device 10 of FIG. 1, redundant descriptions thereof are omitted.

Referring to FIG. 2, the atomizer 130 may include a first heating element 230 and a cigarette 210. The first heating element 230 may be a heater having an elongated shape such that it is easily inserted into the cigarette 210. FIG. 2 shows that the heater having the elongated shape is disposed to be inserted into the cigarette 210, but the present disclosure is not limited thereto. For example, the heater may include a tubular heating element, a plate-type heating element, a needle-type heating element, or a rod-shaped heating element, and may heat the inside or the outside of the cigarette 210 according to the shape of the heating element.

In addition, a plurality of heaters may be disposed in the aerosol-generating device 10. In this case, the plurality of heaters may be disposed to be inserted into the cigarette 210 or may be disposed outside the cigarette 210. In addition, some of the plurality of heaters may be disposed to be inserted into the cigarette 210, and the rest may be disposed outside the cigarette 210. In addition, the shape of the heater is not limited to the shape shown in FIG. 2 and may be manufactured in various shapes.

The cigarette 210 contains an aerosol-generating material. For example, the aerosol-generating material may include, but is not limited to, at least one of glycerin, propylene glycol, ethylene glycol, dipropylene glycol, diethylene glycol, triethylene glycol, tetraethylene glycol, and oleyl alcohol. In addition, the cigarette 210 may contain flavoring agents, wetting agents, and/or other additives such as organic acids. In addition, a flavoring liquid such as menthol or a moisturizing agent may be added to the cigarette 210 by being sprayed onto the cigarette 210.

The cigarette 210 may be manufactured in various ways. For example, the cigarette 210 may be manufactured as a sheet or as a strand. In addition, the cigarette 210 may be manufactured from cut tobacco chopped from a tobacco sheet. In addition, the cigarette 210 may be surrounded by a heat-conducting material. For example, the heat-conducting material may be, but is not limited to, a metal foil such as aluminum foil. For example, the heat-conducting material surrounding the cigarette 210 may improve thermal conductivity applied to the cigarette 210 by evenly distributing heat transferred to the cigarette 210, thereby improving cigarette taste. Additionally, the heat-conducting material surrounding the cigarette 210 may function as a susceptor that is heated by an induction heater. In this case, although not shown in the drawings, the cigarette 210 may further include an additional susceptor in addition to the heat-conducting material surrounding the outside of the cigarette 210.

At least a portion of the cigarette 210 may be inserted into a cigarette insertion passage 220, and may be detachably coupled to the cigarette insertion passage 220.

The first heating element 230 may be surrounded by the cigarette insertion passage 220, and one end of the first heating element 230 may be located inside the cigarette insertion passage 220.

The aerosol-generating device may include a support part 240 supporting the first heating element 230 such that the position of the first heating element 230 with respect to the aerosol-generating device (e.g., the cigarette insertion passage 220) is maintained. A sealing member 250 may be positioned between the first heating element 230 and the support part 240.

In an embodiment, the sealing member 250 may have an O-ring shape with a hollow formed in the center thereof, and may surround the first heating element 230, but is not necessarily limited thereto.

Because the thermoplastic elastomer has excellent heat resistance, even though the thermoplastic elastomer is positioned adjacent to the first heating element 230 and exposed to a high temperature for a long period of time, the thermoplastic elastomer may maintain constant performance. In this light, the thermoplastic elastomer may be a material suitable for the sealing member.

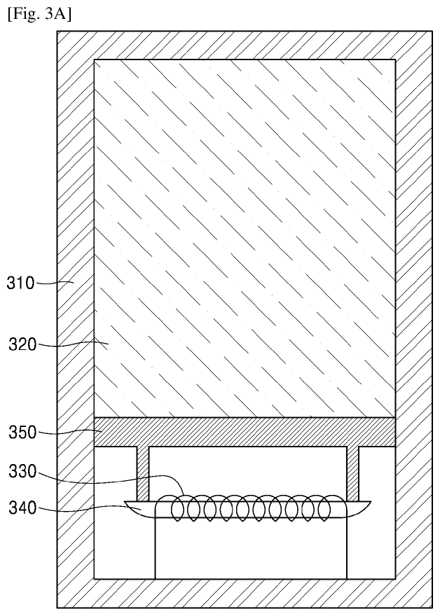

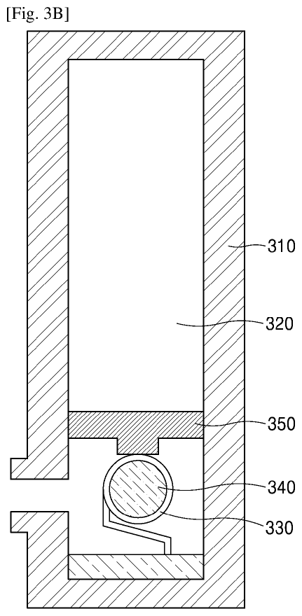

FIG. 3A is a view illustrating the front of a cartridge including a sealing member, and FIG. 3B is a view illustrating the side of the cartridge including the sealing member. Because the aerosol-generating device corresponds to the aerosol-generating device 10 of FIG. 1, redundant descriptions thereof are omitted.

Referring to FIGS. 3A and 3B, the atomizer 130 may include a cartridge 310. The cartridge 310 may include a liquid storage 320 containing a liquid composition, a second heating element 330, and a liquid delivery element 340. The cartridge 310 may contain an aerosol generating material in any one of, for example, a liquid state, a solid state, a gaseous state, or a gel state. The aerosol-generating material may include a liquid composition. For example, the liquid composition may be a liquid including a tobacco-containing material having a volatile tobacco flavor component, or a liquid including a non-tobacco material.

For example, the liquid composition may include one component of water, solvents, ethanol, plant extracts, spices, flavorings, and vitamin mixtures, or a mixture of these components. The spices may include menthol, peppermint, spearmint oil, and various fruit-flavored ingredients, but are not limited thereto. The flavorings may include ingredients capable of providing various flavors or tastes to a user. Vitamin mixtures may be a mixture of at least one of vitamin A, vitamin B, vitamin C, and vitamin E, but are not limited thereto. In addition, the liquid composition may include an aerosol forming agent such as glycerin and propylene glycol.

For example, the liquid composition may include any weight ratio of glycerin and propylene glycol solution to which nicotine salts are added. The liquid composition may include two or more types of nicotine salts. Nicotine salts may be formed by adding suitable acids, including organic or inorganic acids, to nicotine. Nicotine may be a naturally generated nicotine or synthetic nicotine and may have any suitable weight concentration relative to the total solution weight of the liquid composition.

Acid for the formation of the nicotine salts may be appropriately selected in consideration of the rate of nicotine absorption in the blood, the operating temperature of the aerosol generating device 10, the flavor or savor, the solubility, or the like. For example, the acid for the formation of nicotine salts may be a single acid selected from the group consisting of benzoic acid, lactic acid, salicylic acid, lauric acid, sorbic acid, levulinic acid, pyruvic acid, formic acid, acetic acid, propionic acid, butyric acid, valeric acid, caproic acid, caprylic acid, capric acid, citric acid, myristic acid, palmitic acid, stearic acid, oleic acid, linoleic acid, linolenic acid, phenylacetic acid, tartaric acid, succinic acid, fumaric acid, gluconic acid, saccharic acid, malonic acid, or malic acid, or a mixture of two or more acids selected from the group, but is not limited thereto.

The cartridge 310 is operated by an electrical signal or a wireless signal transmitted from the controller 120 to perform a function of generating aerosol by converting the phase of the aerosol generating material inside the cartridge 310 to a gaseous phase. The aerosol may refer to a gas in which vaporized particles generated from an aerosol-generating material are mixed with air.

For example, in response to receiving the electrical signal from the controller 120, the cartridge 310 may convert the phase of the aerosol generating material by heating the aerosol generating material, by using an ultrasonic vibration method, or by using an induction heating method. As another example, when the cartridge 310 includes its own power source, the cartridge 310 may generate aerosol based on an electric control signal or a wireless signal transmitted from the controller 120 to the cartridge 310.

The cartridge 310 may include the liquid storage 320 for accommodating an aerosol-generating material therein, and the second heating element 330 that performs a function of converting the aerosol-generating material of the liquid storage 320 into an aerosol.

When ‘the liquid storage 320 accommodates the aerosol generating material therein’, it means that the liquid storage 320 functions as a container simply holding an aerosol generating material. To this end, for example, the liquid storage 320 may include therein an element impregnated with (or containing) an aerosol generating material, such as a sponge, cotton, fabric, or porous ceramic structure.

The second heating element 330 may include a metal material such as copper, nickel, or tungsten to heat an aerosol-generating material transferred to a liquid delivery element by generating heat by electric resistance. The second heating element 330 may be implemented as, for example, a metal hot wire, a metal hot plate, or a ceramic heating element, and may be implemented as a conductive filament by using a material such as a nichrome wire. The second heating element 330 may be wound around a liquid delivery element or disposed adjacent to the liquid delivery element.

The cartridge 310 may include, for example, a liquid delivery element (i.e., wick) 340 for absorbing the aerosol generating material and maintaining the same in an optimal state for conversion to aerosol, and a heater heating the liquid delivery element to generate aerosol.

The liquid delivery element 340 may include at least one of, for example, a cotton fiber, a ceramic fiber, a glass fiber, and porous ceramic.

For example, a main body of the aerosol-generating device may include a cartridge mounting portion for replaceably supporting the cartridge 310, and the cartridge 310 may be detachably coupled to the main body. The cartridge 310 may contain an aerosol-generating material therein, and the second heating element 330 may be implemented as an electrical resistance coil and may be manufactured in a coil shape surrounding or adjacent to a wick (i.e., the liquid delivery element 340).

According to some embodiments, the sealing member 350 may be disposed above the liquid delivery element 340 and press the liquid delivery element 340. As the sealing member 350 presses the liquid delivery element 340, the position of the liquid delivery element 340 may be maintained. Also, an injection molded product (not shown) fixed to the cartridge 310 may be positioned under the liquid delivery element 340. In this case, one of the injection molding product (not shown) and the scaling member 350 may include a protrusion, and the other may include a groove engaged with the projection. In this way, the position of the liquid delivery element 340 may be firmly maintained.

Because the thermoplastic elastomer has excellent heat resistance, even though the thermoplastic elastomer is positioned adjacent to the second heating element 230 and exposed to a high temperature for a long period of time, the thermoplastic elastomer may maintain constant performance. In this light, the thermoplastic elastomer may be a suitable material for the sealing member.

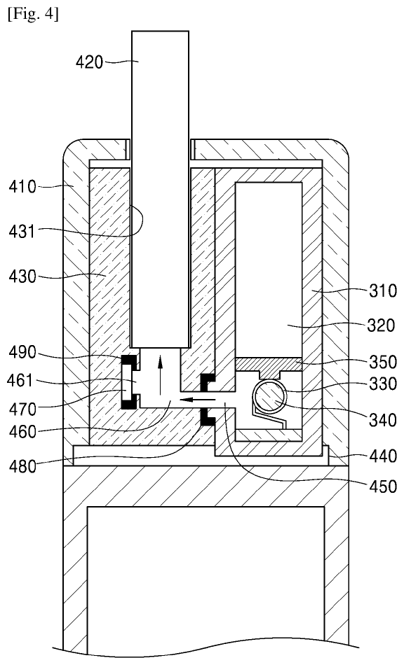

FIG. 4 is a view illustrating an example of an aerosol-generating device including a sealing member. Because the aerosol-generating device corresponds to the aerosol-generating device 10 of FIGS. 1, 3A, and 3B, redundant descriptions thereof are omitted.

According to some embodiments, sealing members 480 and 490 may obstruct a flow of an aerosol, generated in a cartridge 310, in a particular direction. The aerosol-generating device may include a movement passage 460 for allowing the aerosol generated in the cartridge 310 to move in a specific direction (e.g., a direction toward the outside of the aerosol-generating device), and the cartridge 310 may include an outlet 450 for discharging the aerosol toward a cigarette 420. Because the sealing member 480 is disposed between the movement passage 460 and the outlet 450, movement of the aerosol generated in the cartridge in a direction other than a specific direction may be prevented.

For example, a body 410 of the aerosol-generating device may include a cigarette support 430 and a cartridge mounting portion 440. The cigarette support 430 may include a cigarette insertion passage 431 into which at least a portion of a cigarette 420 is inserted. The cigarette support 430 may support the cigarette 420 and transfer heat to the cigarette while the cigarette 420 is inserted into the cigarette insertion passage 431. The cartridge mounting portion 440 may be formed on the side of the cigarette support 430 to replaceably support the cartridge 310. The cartridge 310 may include an outlet 450 for discharging an aerosol toward the cigarette 420, and the cigarette support 430 may include a movement passage 460 for delivering the aerosol delivered through the outlet 450 to the cigarette insertion passage 431. As the sealing member 480 having elasticity is positioned between the outlet 450 for discharging the aerosol toward the cigarette 420 and the movement passage 460 for delivering the aerosol to the cigarette insertion passage 431, the sealing member 480 may seal a space between the outlet 450 and the movement passage 460 (i.e., a space between the cigarette support 430 and the cartridge 310). Accordingly, movement of the aerosol in a direction other than a direction toward the movement passage 460 may be prevented.

In addition, at least one hole 461 may be present in the inner wall of the movement passage 460 (i.e., a wall defining the movement passage 460), and the sealing member 490 is arranged to surround the at least one hole 461, so that movement of the aerosol in a direction other than a specific direction may be hindered.

For example, the aerosol-generating device may include a pressure sensor 470, and in the moving passage 460, there may be a hole 461 for the pressure sensor 470 to measure the pressure of air sucked through the cigarette 420. In this case, as the sealing member 490 having elasticity is positioned between the hole 461 and the pressure sensor 470, a space between the hole 461 and the pressure sensor 470 may be sealed. Accordingly, movement of the aerosol in a direction other than the direction toward the pressure sensor 470 may be prevented.

The sealing members 480 and 490 may each have a hollow formed in the center thereof, and may be in contact with the inner wall of the movement passage 460. The aerosol may flow through the hollow formed in the center of each of the sealing members 480 and 490. One of the sealing member 480 (or the sealing member 490) and the movement passage 460 (or the hole 461) includes a protrusion and the other includes a groove engaged with the protrusion, such that the coupling between the sealing member 480 (or the sealing member 490) and the movement passage 460 (or the hole 461) may be firmer. Therefore, no space is formed between the scaling member 480 (or the sealing member 490) and the movement passage 460 (or the hole 461) even by external pressure or environmental change, thereby preventing the movement of the aerosol in a direction other than a specific direction.

Because the thermoplastic elastomer has excellent processability, a sealing member having a desired size and shape may be manufactured more precisely. In addition, because the thermoplastic elastomer has appropriate elasticity, a sealing member made of the thermoplastic elastomer may be in close contact with adjacent parts, thereby preventing liquid or gaseous materials from leaking out of the movement passage 460. Therefore, the thermoplastic elastomer may be suitable as a material for the sealing member.

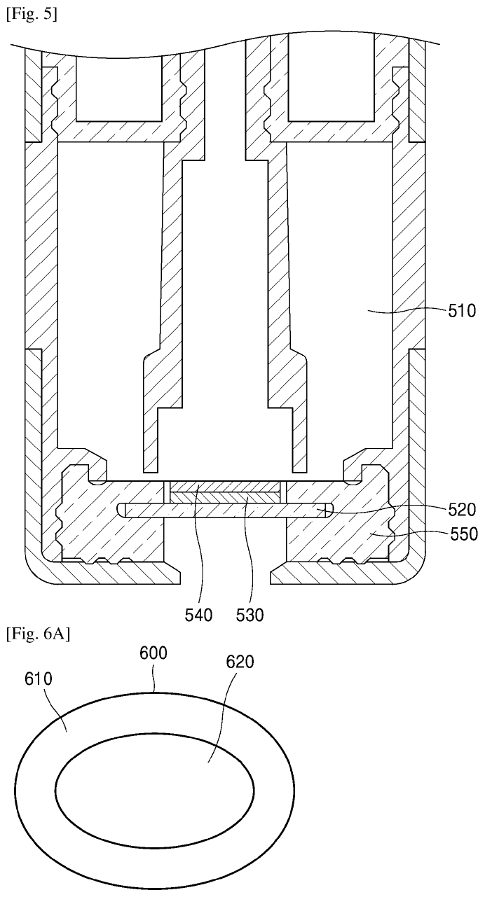

FIG. 5 is a view illustrating an example of an aerosol-generating device including a sealing member. Because the aerosol-generating device corresponds to the aerosol-generating device 10 of FIG. 1, redundant descriptions thereof are omitted.

Referring to FIG. 5, the atomizer 130 may include a liquid storage 510 containing a liquid composition, a vibrator 520, a vibration-receiving unit 530, and a liquid delivery element 540.

The atomizer 130 may contain an aerosol generating material in any one of, for example, a liquid state, a solid state, a gaseous state, or a gel state. The aerosol-generating material may include a liquid composition. For example, the liquid composition may be a liquid including a tobacco-containing material having a volatile tobacco flavor component, or a liquid including a non-tobacco material.

For example, the liquid composition may include one component of water, solvents, ethanol, plant extracts, spices, flavorings, and vitamin mixtures, or a mixture of these components. The spices may include menthol, peppermint, spearmint oil, and various fruit-flavored ingredients, but are not limited thereto. The flavorings may include ingredients capable of providing various flavors or tastes to a user. Vitamin mixtures may be a mixture of at least one of vitamin A, vitamin B, vitamin C, and vitamin E, but are not limited thereto. In addition, the liquid composition may include an aerosol forming agent such as glycerin and propylene glycol.

For example, the liquid composition may include any weight ratio of glycerin and propylene glycol solution to which nicotine salts are added. The liquid composition may include two or more types of nicotine salts. Nicotine salts may be formed by adding suitable acids, including organic or inorganic acids, to nicotine. Nicotine may be a naturally generated nicotine or synthetic nicotine and may have any suitable weight concentration relative to the total solution weight of the liquid composition.

Acid for the formation of the nicotine salts may be appropriately selected in consideration of the rate of nicotine absorption in the blood, the operating temperature of the aerosol generating device 10, the flavor or savor, the solubility, or the like. For example, the acid for the formation of nicotine salts may be a single acid selected from the group consisting of benzoic acid, lactic acid, salicylic acid, lauric acid, sorbic acid, levulinic acid, pyruvic acid, formic acid, acetic acid, propionic acid, butyric acid, valeric acid, caproic acid, caprylic acid, capric acid, citric acid, myristic acid, palmitic acid, stearic acid, oleic acid, linoleic acid, linolenic acid, phenylacetic acid, tartaric acid, succinic acid, fumaric acid, gluconic acid, saccharic acid, malonic acid, or malic acid, or a mixture of two or more acids selected from the group, but is not limited thereto.

The atomizer 130 is operated by an electrical signal or a wireless signal transmitted from the controller 120 to perform a function of generating aerosol by converting the phase of the aerosol generating material inside the atomizer 130 to a gaseous phase. The aerosol may refer to a gas in which vaporized particles generated from an aerosol-generating material are mixed with air.

For example, in response to receiving the electrical signal from the controller 120, the atomizer 130 may convert the phase of the aerosol generating material by heating the aerosol generating material, by using an ultrasonic vibration method, or by using an induction heating method. As another example, when the atomizer 130 includes its own power source, the atomizer 130 may generate aerosol based on an electric control signal or a wireless signal transmitted from the controller 120 to the atomizer 130.

The atomizer 130 may change the phase of an aerosol-generating material by using an ultrasonic vibration method of atomizing the aerosol-generating material with ultrasonic vibration. The atomizer 130 may include, for example, a liquid storage 510 for accommodating the aerosol-generating material therein, and a vibrator 520 for converting the aerosol-generating material of the liquid storage 510 into an aerosol.

When ‘the liquid storage 510 accommodates the aerosol generating material therein’, it means that the liquid storage 510 functions as a container simply holding an aerosol generating material. To this end, the liquid storage 510 may include therein an element impregnated with (or containing) an aerosol generating material, such as a sponge, cotton, fabric, or porous ceramic structure.

The vibrator 520 may generate vibration of a short period. The vibration generated by the vibrator 520 may be ultrasonic vibration, and the frequency of the ultrasonic vibration may be, for example, 100 kHz to 3.5 MHz. The aerosol-generating material may be vaporized and/or atomized into an aerosol by the short-period vibration generated from the vibrator 520.

The vibrator 520 may include, for example, piezoelectric ceramic. The piezoelectric ceramic is a functional material that may convert electricity and a mechanical force into one another by generating electricity (i.e., voltage) by a physical force (i.e., pressure) and conversely generating vibration (i.e., mechanical force) when electricity is applied. Therefore, vibration (i.e., physical force) may be generated by electricity applied to the vibrator 520, and small physical vibrations may split the aerosol-generating material into small particles that may be atomized into an aerosol.

The vibrator 520 may be electrically connected to a circuit by a pogo pin or a C-clip. Accordingly, the vibrator 520 may generate vibration by receiving a current or voltage from the pogo pin or the C-clip. However, the type of element connected to supply a current or voltage to the vibrator 520 is not limited thereto.

The atomizer 130 may include, for example, the vibration-receiving unit 530 that receives vibration generated from the vibrator 520 and converts the aerosol-generating material transmitted from the liquid storage 510 into an aerosol.

In addition, the atomizer 130 may further include a liquid delivery element 540 for delivering the liquid composition of the liquid storage 510 to the vibration-receiving unit 530. For example, the liquid delivery element 540 may be a wick including at least one of cotton fiber, ceramic fiber, glass fiber, and porous ceramic, but is not limited thereto.

The atomizer 130 also may be implemented as a heating element having a mesh shape or a plate shape, the heating element performing both a function of maintaining optimal conditions for absorbing an aerosol-generating material without the use of a liquid delivery element and converting the absorbed aerosol-generating material into an aerosol and a function of generating an aerosol by heating the aerosol-generating material.

According to some embodiments, the sealing member 550 may be disposed on one end of the liquid delivery element. In addition, the sealing member 550 may have a disk shape and surround the liquid delivery element 540 and at least a portion of the vibrator 520.

For example, the sealing member 550 may have a disk shape, and there may be a space for accommodating the liquid delivery element 540 (e.g., wick) and the vibrator 520 inside the sealing member 550. The accommodation space inside the scaling member 550 may be in contact with the wick 540 and the vibrator 520 to surround the outer circumferential surfaces of the wick 540 and the vibrator 520. Accordingly, the position of the wick 540 and the vibrator 520 may be prevented despite an external force applied to the wick 540 and the vibrator 520 or vibration generated by the vibrator 520. In addition, since the sealing member 550 is in close contact with the outer circumferential surface of the wick 540, the aerosol-generating material is transmitted only to the wick 540 and not directly to the vibrator 520, thereby inhibiting chemical corrosion of the vibrator 520.

Accordingly, a thermoplastic elastomer having excellent processability and excellent durability may be a material suitable for the sealing member.

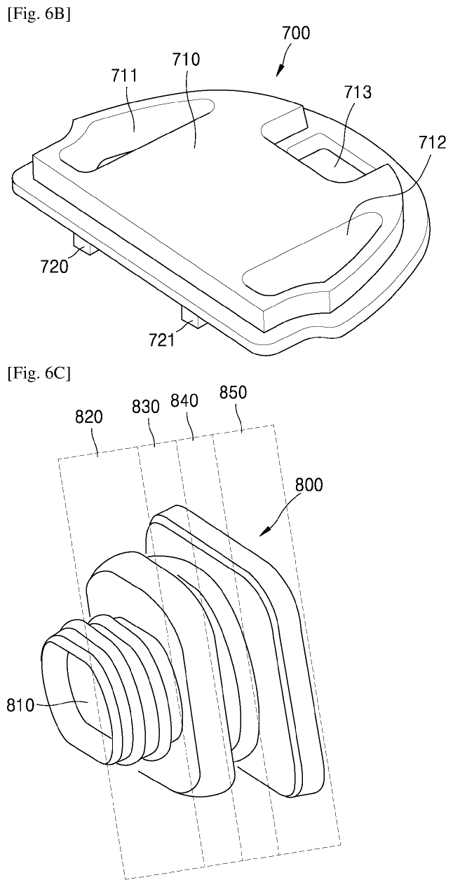

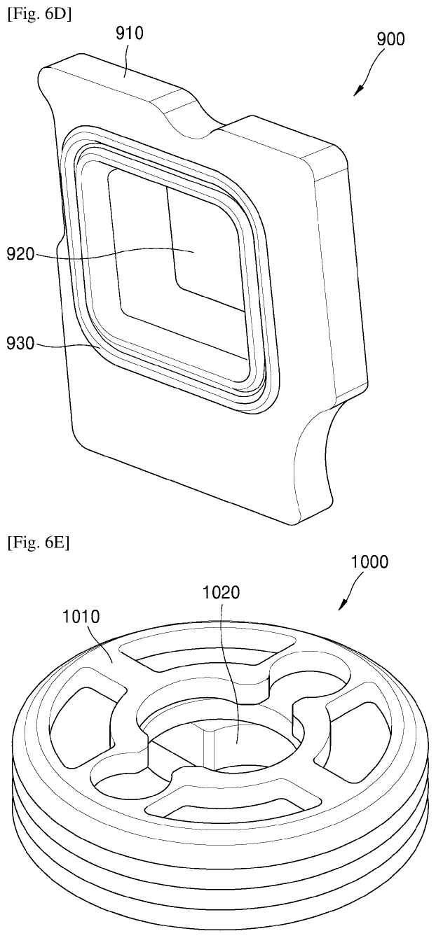

FIGS. 6A to 6E are views illustrating examples of a sealing member for an aerosol-generating device.

A sealing member 600 of FIG. 6A may be the sealing member 250 included in the aerosol-generating device of FIG. 2.

Referring to FIG. 6A, the sealing member 600 may have a ring-shaped structure 610 including a hollow 620. The ring-shaped structure 610 may have, for example, an O-ring shape, but is not limited thereto and may have a polygonal shape or a partially streamlined shape.

A sealing member 700 of FIG. 6B may be the sealing member 350 included in the cartridge of FIGS. 3A and 3B.

Referring to FIG. 6B, the sealing member 700 may include a semicircular plane 710 and steps 720 and 721. The steps 720 and 721 may come into contact with a portion of a liquid delivery element (not shown) and may be formed on one surface of the semicircular plane 710. The shapes of the steps 720 and 721 may be the same as the shape of a contact surface of the liquid delivery element. Holes 711, 712, and 713 for passing liquid or gas may be formed on the semicircular plane 710 of the sealing member 700. The shape of the holes 711, 712, and 713 may be similar to the shape of the semicircular plane 710, but is not necessarily limited thereto. For example, the holes 711, 712, and 713 may have a circular shape, a polygonal shape, or a partially streamlined shape.

A sealing member 800 of FIG. 6C may be the sealing member 480 included in the aerosol-generating device of FIG. 4. Referring to FIG. 6C, the sealing member 800 may include four layers, i.e., first to fourth layers 820, 830, 840, and 850, having different cross-sectional areas and a hollow 810. The shape of one surface of the first layer 820 may be the same as the shape of the inner wall of a movement passage (not shown), and the shape of one surface of the fourth layer 850 may be the same as the shape of the outer circumferential surface of an outlet (not shown) for discharging an aerosol. The second layer 830 and the third layer 840 may have different cross-sectional areas to form a step. A hollow 810, which passes through the first to fourth layers 820, 830, 840, and 850 and through which liquid or gas may move, may be formed in the first to fourth layers 820, 830, 840, and 850. The hollow 810 may have, for example, a circular shape, a polygonal shape, or a partially streamlined shape. However, the present disclosure is not necessarily limited thereto.

A sealing member 900 of FIG. 6D may be the sealing member 490 included in the aerosol-generating device of FIG. 4. Referring to FIG. 6D, the sealing member 900 may include a rectangular plane 910 and a hollow 920. The shape of the hollow 920 may be the same as the shape of the outer circumferential surface of a pressure sensor (not shown). For example, the hollow 920 may be in the shape of a rectangle with rounded corners, but the present disclosure is not limited thereto. A step 930 surrounding the periphery of the hollow 920 may be formed on one surface of the rectangular plane 910. However, the present disclosure is not necessarily limited thereto.

A sealing member 1000 of FIG. 6E may be the sealing member 550 included in the aerosol-generating device of FIG. 5. Referring to FIG. 6E, the sealing member 1000 may include a cylindrical structure 1010 and a hollow 1020. The shape of the hollow 1020 may correspond to the shapes of the outer circumferential surfaces of a vibrator (not shown), a vibration-receiving unit (not shown), and a liquid delivery element (not shown). The cylindrical structure 1010 may be composed of one or more layers surrounding at least one of the vibrator, the vibration-receiving unit, and the liquid delivery element. For example, the cylindrical structure 1010 may be a single layer surrounding all of the vibrator, the vibration-receiving unit, and the liquid delivery element, but is not necessarily limited thereto. The cylindrical structure 1010 may accommodate parts for electrical connection capable of transmitting power to the vibrator, and for this purpose, a space for accommodating the parts for electrical connection may be further formed inside the cylindrical structure 1010.

The thermoplastic elastomer has not been used as a material for a sealing member or other elements in the conventional electronic cigarette field. However, unlike conventionally used materials, the sealing member including the thermoplastic elastomer according to the present disclosure may be accurately and precisely manufactured to match a planned value with a small error, and has excellent elasticity. Accordingly, a frictional force between the sealing member and an element in contact with the sealing member, for example, the movement passage 460 or the outlet 450, is improved. As a result, a coupling force between the movement passage 460 and the sealing member, and a coupling force between the outlet 450 and the sealing member are improved, and furthermore, a coupling force between the cigarette support 430 including the movement passage 460 and the cartridge 310 including the outlet 450 is improved.

Those of ordinary skill in the art related to the present embodiments may understand that various changes in form and details can be made therein without departing from the scope of the characteristics described above. The disclosed methods should be considered in a descriptive sense only and not for purposes of limitation. The scope of the present disclosure is defined by the appended claims rather than by the foregoing description, and all differences within the scope of equivalents thereof should be construed as being included in the present disclosure.

1. An aerosol-generating device comprising:
a battery;
an atomizer configured to generate an aerosol by atomizing an aerosol-generating material; and
a sealing member disposed on one end of the atomizer and including a thermoplastic elastomer (TPE),
wherein the thermoplastic elastomer has a melt flow index of 1.8 g/10 min to 80.0 g/10 min.

2. The aerosol-generating device of claim 1, wherein the thermoplastic elastomer includes at least one of thermoplastic styrenic copolymer (TPS), thermoplastic vulcanized rubber (TPV), thermoplastic polyester (TPEE), thermoplastic polyurethane (TPU), and thermoplastic polyolefin (TPO).

3. The aerosol-generating device of claim 1, wherein the thermoplastic elastomer has a hardness of 20 shore A to 85 shore A.

4. The aerosol-generating device of claim 1, wherein
the atomizer includes a first heating element and a cigarette,
the first heating element is a heater having an elongated shape,
the aerosol-generating device includes a support part for supporting the first heating element, and the sealing member is in contact with both the first heating element and the support part.

5. The aerosol-generating device of claim 4, wherein the sealing member has an O-ring shape with a hollow formed in a center thereof, and the sealing member surrounds the first heating element.

6. The aerosol-generating device of claim 1, wherein the atomizer includes a cartridge,
wherein the cartridge includes: a liquid storage containing a liquid composition; a second heating element; and a liquid delivery element.

7. The aerosol-generating device of claim 6, wherein the sealing member is arranged above the liquid delivery element such that the sealing member presses the liquid delivery element.

8. The aerosol-generating device of claim 6, wherein the sealing member obstructs a flow of a generated aerosol in a predetermined direction.

9. The aerosol-generating device of claim 8, further comprising:
a movement passage through which the generated aerosol moves toward outside of the aerosol-generating device,
wherein the cartridge includes an outlet for discharging the aerosol toward the movement passage,
wherein the sealing member is disposed between the movement passage and the outlet.

10. The aerosol-generating device of claim 8, further comprising:
a movement passage through which the generated aerosol moves toward outside of the aerosol-generating device,
wherein at least one hole is formed in an inner wall of the movement passage,
wherein the sealing member is arranged to surround the at least one hole.

11. The aerosol-generating device of claim 8, further comprising:
a movement passage through which the generated aerosol moves toward outside of the aerosol-generating device,
wherein the sealing member has a hollow formed in a center thereof, and is in contact with an inner wall of the movement passage.

12. The aerosol-generating device of claim 1, wherein the atomizer includes: a liquid storage containing a liquid composition; a vibrator; a vibration-receiving unit; and a liquid delivery element.

13. The aerosol-generating device of claim 12, wherein the sealing member is disposed on one end of the liquid delivery element.

14. The aerosol-generating device of claim 12, wherein the sealing member has a disc shape and surrounds the liquid delivery element and at least a portion of the vibrator.

15. A sealing member for an aerosol-generating device, the sealing member comprising:
a thermoplastic elastomer having a melt flow index of 1.8 g/10 min to 80.0 g/10 min.
